(19) United States
(12) Patent Application Publication
(10) Pub. No.: US 2011/0050715 A1
(43) Pub. Date: Mar. 3, 2011

(54) METHOD OF REMAPPING MEMORY

(75) Inventors: Ying-Chih Lu, Taipei City (TW); Szu-Hsien Lee, Taipei City (TW); Yu-Hui Wang, Taipei City (TW)

(73) Assignee: INVENTEC CORPORATION, Taipei City (TW)

(21) Appl. No.: 12/579,324

(22) Filed: Oct. 14, 2009

(30) Foreign Application Priority Data
Sep. 1, 2009 (TW) 98129450

(51) Int. Cl. G06F 12/02

(52) U.S. Cl. 345/543

(57) ABSTRACT

A method of remapping memory, which is suitable for a server without a video graphics array (VGA), is provided. In the invention, a video memory buffer block is set in a system memory. First, a power on self test (POST) is executed for initializing the system memory. Next, a remap function is enabled. Then, a base address and a size of the video memory buffer block are set into a remap register of a chipset. Finally, the video memory buffer block is remapped into a memory address space originally mapped with a system management mode block according to the remap register.

### CROSS-REFERENCE TO RELATED APPLICATION

This application claims the priority benefit of Taiwan application serial no. 98129450, filed on Sep. 1, 2009. The entirety of the above-mentioned patent application is hereby incorporated by reference herein and made a part of this specification.

### BACKGROUND OF THE INVENTION

1. Field of the Invention

The invention relates to a method of operating a memory, and more particularly, to a method of remapping a memory of a server having a video graphics array (VGA) removed therefrom.

2. Description of Related Art

In recent years, network-attached storage (NAS) servers using the internet as an expansion of storage space gradually become popularized. The user can store file data in a storage apparatus on the internet through internet browsing and accessing so as to simply expand storage space. Moreover, through internet accessing, not only is the maximum limit of a single computer apparatus connecting to storage devices overcome to obtain unlimited expansion of storage space, but the advantage of sharing data from multiple persons or multiple apparatuses is also simply achieved through the internet.

Since NAS servers are permanently stored in the control room, the user does not need to check the status of NAS servers frequently. Thus, in order to save the production cost, the video graphics array (VGA) on the mother board is usually removed in the current design of NAS servers. However, as a consequence, no video memory buffer is present in the system to be used by the serial console redirection program.

Generally, after scanning the video memory buffer, the serial console redirection program displays data to the remote console terminal through the serial port controller. At this time, as NAS servers do not have video memory buffers, if the initialization frame of the OPTION ROM is correctly to be displayed remotely, a remote display error then results.

### SUMMARY OF THE INVENTION

The invention is directed to a method of remapping a memory, so as to set a video memory buffer block in a system memory as a virtual video memory buffer block in a video graphics array (VGA).

The invention is directed to a method of remapping a memory, suitable for a server having a VGA removed therefrom. Here, a memory system of the server includes a system management mode (SMM) block. The method includes further setting an additional video memory buffer block in the system memory. Firstly, a power on self test (POST) is executed to initialize the system memory. Thereafter, a remap function is enabled. Afterwards, a base address and a size of the video memory buffer block are set into a remap register of a chipset. Finally, according to the remap register, the video memory buffer block is remapped into a memory address space originally mapped with the SMM block.

According to an embodiment of the invention, the remap function is enabled when a serial console redirection program is executed.

According to an embodiment of the invention, a frame is displayed to a remote console terminal according to the video memory buffer block after the step of remapping the video memory buffer block into the memory address space. Furthermore, the video memory buffer block is set to be unavailable and reported to an operating system, so that the operating system does not use the video memory buffer block.

According to an embodiment of the invention, the method of remapping the memory further includes enabling the remapping function before the operating system controls a universal asynchronous receiver/transmitter (UART). In addition, after the memory address space in the SMM block is remapped into the video memory buffer block, the operating system is checked to see whether the UART has been controlled. For example, whether a UART entry in an interrupt table has been changed is checked, so as to determine the operating system to be controlling the UART when the UART entry is changed. If the operating system has controlled the UART, the remap function is then disabled. Additionally, the video memory buffer block is set to be available and is reported to the operating system.

In light of the foregoing, in the invention, a video memory buffer block is set within the system memory of the server having the VGA removed therefrom, and the buffer of the VGA is therefore simulated. Accordingly, the initialization frame of the server is transmitted to the remote console terminal through this video memory buffer block.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a mapping of a system memory according to an embodiment of the invention.

FIG. 2 is a flowchart illustrating a method of remapping a memory according to an embodiment of the invention.

FIG. 3 is a flowchart illustrating a method of freeing a memory address space under an operating system according to an embodiment of the invention.

### DESCRIPTION OF EMBODIMENTS

In a current design of a network-attached storage (NAS) server, a video graphics array (VGA) on a mother board is usually removed. However, as a consequence, no video memory buffer is present in the system for a serial console redirection program to use. At this time, when an OPTION ROM is selected to access the VGA video buffer directly, an erroneous remote display then results. Accordingly, a method of remapping a memory is provided in the invention to provide a video memory buffer block as a virtual buffer of a VGA. In order to make the present invention more comprehensible, embodiments are described below as examples to prove that the invention can actually be realized.

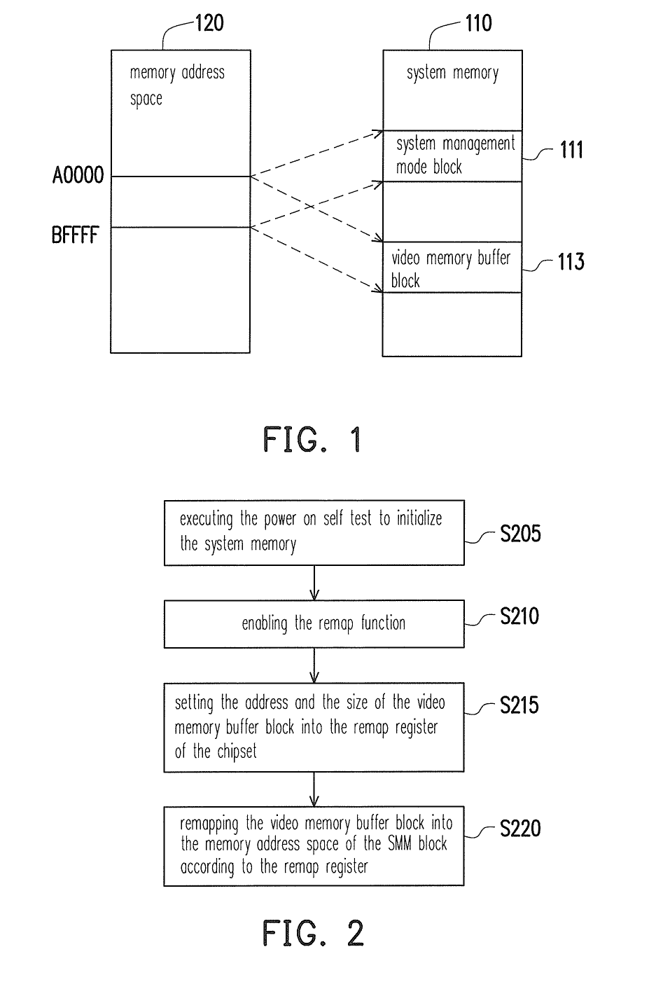

FIG. 1 is a schematic view of a mapping of a system memory according to an embodiment of the invention. Referring to FIG. 1, the present embodiment is suitable for a server having a VGA removed therefrom. Here, a system memory 110 of the server not only includes a system management mode (SMM) block 111, but also sets a video memory buffer block 113.

For example, in the system memory 110, a position of a block of 128 Kbyte at 16 MB is used as the video memory buffer block 113 to simulate a buffer of the VGA. Moreover, memory address spaces A0000˜BFFFF are utilized jointly as the SMM block 111 and the video memory buffer block 113. Herein, when the server is in a SMM, the SMM block 111 is mapped to the memory address spaces A0000˜BFFFF. Under other modes, the video memory buffer block 113 is to be remapped into the memory address spaces A0000˜BFFFF.

Another example is described in the following to illustrate steps in the method of remapping the memory in detail. FIG. 2 is a flowchart illustrating a method of remapping a memory according to an embodiment of the invention. Referring to FIG. 1 and FIG. 2 simultaneously, firstly, in step S205, a power on self test is executed to initialize the system memory 110.

Next, in step S210, a remap function is executed. Thereafter, in step S215, a base address and a size of the video memory buffer block 113 are set into a remap register of a chipset. For example, when executing a serial console redirection program, the remap register of the chipset is set by using the remap function of the chipset (i.e. a north bridge chip), so that the remap function is performed to the system memory 110. According to FIG. 1, the video memory buffer block 113 of the system memory 110 is mapped to the memory address spaces A0000˜BFFFF for using the video memory buffer block 113 to simulate the buffer of the VGA.

Finally, in step S220, the video memory buffer block 113 is remapped into a memory address space of the SMM block 111 according to the remap register. Afterwards, a frame is displayed to a remote console terminal through the video memory buffer block 113. Further, the video memory buffer block 113 is set to be unavailable and reported to an operating system (i.e. reported through int15h function cell E820), so that the operating system does not use the video memory buffer block 113.

Accordingly, regardless of a preboot eXecution Environment (PXE) or an OPTION ROM, the video memory buffer block 113 can be accessed directly so as to transmit an initialization frame to the remote console terminal for display.

In addition, when a central processing unit is reading the memory address spaces A0000˜BFFFF, the SMM block 111 is then read under the SMM, and the video memory buffer block 113 is then read under the non-SMM.

It should be noted that the step of enabling the remap function is performed before the operating system controls a universal asynchronous receiver/transmitter (UART). When the operating system has controlled the UART, the video memory buffer block 113 is not required. Consequently, the video memory buffer block 113 is freed for the operating system to use. Another embodiment is illustrated in the following.

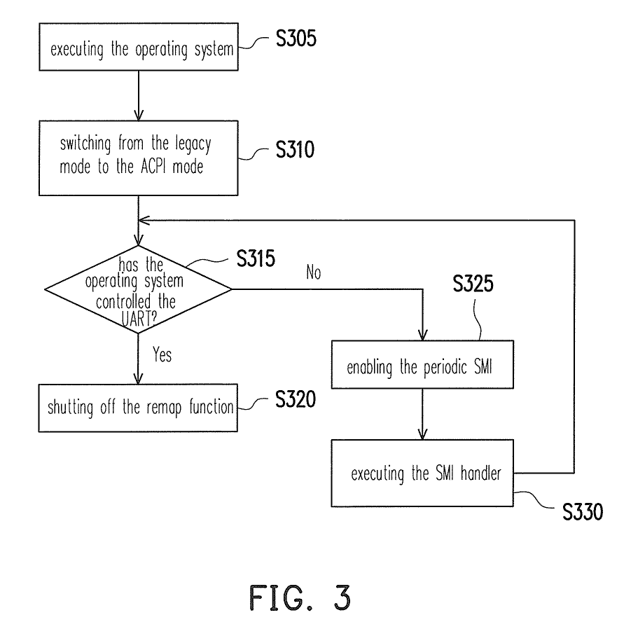

FIG. 3 is a flowchart illustrating a method of freeing a memory address space under an operating system according to an embodiment of the invention. Referring to FIG. 3, the operating system is executed in step S305. Next, as illustrated in step S310, the operating system switches from a legacy mode to an advanced configuration and power interface (ACPI) mode by issuing software SMI.

Later, in step S315, whether the operating system has controlled the UART is determined under SMI handler. In other words, after the video memory buffer block 113 is remapped into the memory address spaces A0000˜BFFFF of the SMM block 111, whether the operating system has controlled the UART is checked. For example, whether a UART entry in an interrupt table has been changed is checked, so as to determine the operating system to be controlling the UART when the UART entry is changed.

When the operating system has controlled the UART, as shown in step S320, the remap function is then disabled. Moreover, the video memory buffer block 113 is set to be available and reported to the operating system through int15h function call E820h, so that the video memory buffer region 113 can be used by the operating system.

On the other hand, in step S315, when the operating system has not yet controlled the UART, the periodic system management interrupt (SMI) (i.e. triggering the SMI once every one minute) is enabled as illustrated in step S325. Afterwards, as illustrated in step S330, a SMI handler is executed until the operating system controls the UART, and the periodic SMI is then disabled.

In summary, in the invention, a video memory buffer block is set in the system memory, and this video memory buffer block and the SMM block use the same memory address space jointly. Accordingly, in the normal mode (non-SMM mode), the SMM block is not exposed and therefore prevented from accidental damages. Furthermore, no modifications are required from manufacturers by using the methods aforementioned. Therefore, when executing the serial console redirection program, the frame can be correctly displayed remotely. When the operating system has controlled the UART, the video memory buffer block originally adopted as the VGA is freed to increase the volume of the system memory to be used by the operating system.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of remapping a memory, suitable for a server having a video graphics array removed therefrom, wherein a system memory of the server comprises a system management mode block, and the method comprises:
setting a video memory buffer block in the system memory;
executing a power on self test to initialize the system memory;
enabling a remap function;
setting a base address and a size of the video memory buffer block into a remap register of a chipset; and
according to the remap register, remapping the video memory buffer block into a memory address space originally mapped with the system management mode block.

2. The method of remapping the memory as claimed in claim 1, wherein the step of enabling the remap function comprises:
executing a serial console redirection program to enable the remap function.

3. The method of remapping the memory as claimed in claim 1, wherein after the step of remapping the video memory buffer block into the memory address space, the method further comprises:
displaying a frame to a remote console terminal according to the video memory buffer block.

4. The method of remapping the memory as claimed in claim 1, wherein after the step of remapping the video memory buffer block into the memory address space, the method further comprises:
setting the video memory buffer block to be unavailable and reporting to an operating system, so that the operating system does not use the video memory buffer block.

5. The method of remapping the memory as claimed in claim 1, further comprising:
enabling the remap function before controlling a universal asynchronous receiver/transmitter (UART) with an operating system.

6. The method of remapping the memory as claimed in claim 5, wherein after the step of remapping video memory buffer block into the memory address space, the method further comprises:
checking whether the operating system has controlled the UART.

7. The method of remapping the memory as claimed in claim 6, wherein the step of checking whether the operating system has controlled the UART comprises:
checking whether a UART entry in an interrupt table has been changed, so as to determine the operating system to be controlling the UART when the UART entry is changed.

8. The method of remapping the memory as claimed in claim 7, wherein after the step of controlling the UART by the operating system, the method further comprises:
disabling the remap function.

9. The method of remapping the memory as claimed in claim 7, wherein after the step of controlling the UART by the operating system, the method further comprises:
setting the video memory buffer block to be available and reporting to the operating system.
